(19) United States
(12) Patent Application Publication
(10) Pub. No.: US 2006/0170626 A1
(43) Pub. Date: Aug. 3, 2006

(54) Current-driven data driver IC with decreased number of transistors

(75) Inventor: Han-Su Pae, Gyeonggi-do (KR)

Correspondence Address: MYERS BIGEL SIBLEY & SAJOVEC, PO BOX 37428, RALEIGH, NC, 27627, US

(73) Assignee: Samsung Electronics Co., Ltd.

(21) Appl. No.: 11/330,649

(22) Filed: Jan. 12, 2006

(30) Foreign Application Priority Data
Feb. 3, 2005 (KR) 10-2005-010052

(51) Int. Cl. G09G 3/30

(52) U.S. Cl. 345/76

(57) ABSTRACT

A current-driven data driver IC includes a bias voltage generator configured to generate a plurality of bias voltages, a decoder configured to select one of the plurality of bias voltages based on a video data signal, and a digital-to-analog converter configured to receive the selected bias voltage and to responsively generate an output current based on the video data signal. A display device includes a display panel including a plurality of scan lines, a plurality of data lines intersecting the scan lines, and a plurality of pixels connected to the scan lines and the data lines, a timing controller configured to receive a video signal and to output a video data signal for driving the display panel, a scan driver IC configured to sequentially activate the scan lines, and a current-driven data driver IC configured to provide a drive current for the display device.

### CLAIM OF PRIORITY AND CROSS REFERENCE TO RELATED APPLICATION

This application claims priority under 35 U.S.C. § 119 from Korean Patent Application No. 2005-010052, filed on Feb. 3, 2005, the disclosure of which is hereby incorporated by reference herein as if set forth in its entirety.

### FIELD OF THE INVENTION

The present invention relates to a display device, and more particularly, to a current-driven data driver integrated circuit (IC) with a decreased number of current-driven transistors.

### BACKGROUND

Cathode ray tubes (CRTs) are heavy and bulky, and are driven at a relatively high voltage. In order to address the disadvantages of CRT displays, flat panel displays (FPDs) that are lightweight and dissipate less power have been developed. FPDs may be classified into non-emissive displays and emissive displays. An example of a non-emissive display is a liquid crystal panel (LCD), and examples of the emissive displays are plasma display panels (PDP), electroluminescent displays (ELD), field emission displays (FED), light emitting diode (LED) displays, vacuum fluorescent displays (VFD), and so on. In addition, FPDs can be classified into voltage-driven displays and current-driven displays according to methods of driving the flat panel display. PDP and LCDs are examples of voltage-driven displays, and ELD and LED displays are examples of current-driven displays.

The ELD is a representative current-driven display and is a self-luminous device that emits light by using the recombination of electrons and holes. ELDs may be classified into inorganic ELDs and organic ELDs according to materials and structures used therein.

Electroluminescence is an emission phenomenon using inorganic phosphor powders. Electroluminescence using inorganic materials had not been used for display devices, as it was merely thought that EL would be useful for a backlight. The reason why inorganic EL did not attract attention for display devices is that the inorganic EL devices could not produce a full color because of the absence of efficient blue emitting materials. Organic ELDs were actively researched in the 1990's and are now considered as a next-generation display device. An organic ELD emits light by applying a current to an organic thin film.

An EL phenomenon by an organic compound was discovered by Anthracene in the 1960's. An ultra-thin bi-layer organic EL device having improved luminous efficiency and stability was published by Tang and VanSlyke of Eastman Kodak Company in 1987, and a monochrome organic EL display was commercialized by Pioneer in late 1997. A 5.5″ true-color organic EL display was demonstrated by Sanyo-Kodak at the SID meeting in 2000.

An organic EL display can be driven by a lower current than other displays such as TFT-LCDs, PDPs, FEDs, etc. In addition, organic EL displays are self-luminous and thus exhibit high visibility. Moreover, because an organic EL display does not require a backlight assembly, its display thickness can be made smaller than that of a TFT-LCD. Compared with an LCD display, an organic EL display may have a rapid response time and/or a wide viewing angle. Therefore, the organic EL display is considered as one of the next-generation flat panel displays that can reproduce a high-quality moving image. Technical attempts to commercialize the organic EL display are now in progress. Recently, organic EL displays have been used as a display for small-sized information devices, such as IMT-2000 system, PDA, etc. Organic EL displays are expected to compete with TFT-LCDs in the markets of notebook computers, flat TVs, etc.

FIG. 1 is a schematic view of a conventional organic EL device, which illustrates the emission principle of an EL display.

Referring to FIG. 1, an organic EL device includes an electron injecting layer 2, an electron transporting layer 3, an emitting layer 4, a hole transporting layer 5, and a hole injecting layer 6, which are sequentially formed between a cathode 1 and an anode 7. The anode 7 may be a transparent electrode and the cathode 1 may be a metal electrode. If a sufficient voltage is applied between the anode 7 and the cathode 1, electrons generated from the cathode 1 move to the emitting layer 4 through the electron injecting layer 2 and the electron transporting layer 3. Also, holes generated from the anode 7 move to the emitting layer 4 through the hole injecting layer 6 and the hole transporting layer 5. Accordingly, the electrons and the holes, which are respectively supplied from the electron transporting layer 3 and the hole transporting layer 5, may recombine in the emitting layer 4, thereby emitting light. The emitted light is irradiated through the anode 7 to the outside, so that an image is displayed. The brightness of the organic EL device is proportional not to the applied voltage, but to a supply current. Therefore, the anode 7 may be connected to a constant current source (not shown).

A data driver IC provided in a current-driven organic EL display is driven by a current. The data driver IC drives the pixels of the organic EL panel. FIG. 2 is a circuit diagram of a conventional data driver IC 200. Referring to FIG. 2, the conventional data driver IC 200 includes a reference current generator 210 and a number of k-bit digital-to-analog converters 220 and 230.

The reference current generator 210 includes a PMOS transistor 211 and a current source 212. The PMOS transistor 211 has a source connected to a voltage VH, and a gate and a drain connected together. The k-bit digital-to-analog converters 220 and 230 are serially connected to the gate (or the drain) of the PMOS transistor 211. A current generated from the reference current generator 210 is supplied to the k-bit digital-to-analog converters 220 and 230 in a current mirror scheme.

The digital-to-analog converters 220 and 230 are connected to data lines D1 to Dn, respectively. Since the k-bit digital-to-analog converters 220 and 230 can have the same circuit configuration, a circuit configuration of the k-bit digital-to-analog converter 220 alone will be described below.

The k-bit digital-to-analog converter 220 includes a plurality of PMOS transistors and a plurality of switches B0 to Bk-1. The PMOS transistors serve as current sources. The PMOS transistors have sources connected to the voltage VH, drains connected to their corresponding switches B0 to Bk-1, and gates connected to a bias voltage VB generated from the reference current generator 210, respectively. The switches B0 to Bk-1 are respectively controlled by bits corresponding to video data signals DATA1 to DATAn provided from a timing controller. For example, the video data signals DATA1[0:2^{k}−1] are signals for driving a first data line D1, and 2^{k} number of the individual video data signals DATA1[0] to DATA1[2^{k}−1] control the operations of the respective switches. The video data signals DATAn[0:2^{k}−1] are signals for driving a n-th data line Dn, and the individual video data signals DATAn[0] to DATAn[2^{k}−1] control the operations of the respective switches.

FIG. 3 is a circuit diagram of a digital-to-analog converter 220 having a 3-bit gray scale. The gray scale represents a concentration of color and is associated with the resolution of the display device. A first switch B0 is connected to one PMOS transistor, a second switch B1 is connected to two PMOS transistors, and a third switch B2 is connected to four PMOS transistors. Accordingly, 7 (=1+2+4) PMOS transistors are required to configure the 3-bit digital-to-analog converter 220. The respective switches B0 to B2 are controlled by bits corresponding to 2³ number of video data signals DATA1[0:7], which are provided from a timing controller. For example, the video data signal DATA1[0] turns off all of the three switches so that a current flowing through the first data line D1 becomes 01. The video data signal DATA1[7] turns on all of the three switches so that a current flowing through the first data line D1 becomes 71. In this manner, the operations of the respective switches are controlled according to the video data signals DATA1[0:7], so that a current ranging from 01 to 71 can flow through the first data line D1.

As the resolution of the display device increases, the number of bits representing the gray scale increases. For example, a digital-to-analog converter having a 6-bit gray scale requires six switches. The respective switches are connected to one, two, four, eight, sixteen, and thirty-two PMOS transistors. Accordingly, in a conventional digital-to-analog converter, 63 (=1+2+4+8+16+32) PMOS transistors are required to configure a 6-bit digital-to-analog converter.

As EL display panel sizes become larger and higher resolution is demanded, it may be desirable to increase the gray scale. However, if the gray scale increases, the number of PMOS transistors increases exponentially. Thus, the circuit configuration of the data driver IC 200 will be complicated and the chip size will be increased.

### SUMMARY OF THE INVENTION

Some embodiments of the invention provide a current-driven data driver IC including a bias voltage generator configured to generate a plurality of bias voltages, a decoder configured to select one of the plurality of bias voltages based on a video data signal, and a digital-to-analog converter configured to receive the selected bias voltage and to responsively generate an output current based on the video data signal.

The bias voltage generator may be configured to receive an external power supply voltage and to generate the plurality of bias voltages in response to the power supply voltage.

The digital-to-analog converter may include a plurality of PMOS transistors configured to provide substantially equal current flows therethrough, and a plurality of switches connected to drains of the PMOS transistors and configured to turn the PMOS transistors on and/or off, thereby causing the PMOS transistors serve as a plurality of current sources.

Respective ones of the MOS transistors may have sources connected to a power supply voltage, gates connected to the bias voltage selected by the decoder, and drains connected to one of the plurality of switches.

The switches may be controlled by bits corresponding to the video data signal.

The current-driven data driver IC may further include a register configured to store the video data signal, and a level shifter configured to convert a voltage level of the video data signal and to provide the converted video data signal to the decoder and the digital-to-analog converter.

A current-driven data driver IC according to further embodiments of the invention includes a first bias voltage generator configured to generate a first bias voltage, and a second bias voltage generator coupled to the first bias voltage generator and configured to receive the first bias voltage and to responsively generate a plurality of second bias voltages. A decoder is coupled to the second bias voltage generator and is configured to receive the plurality of first bias voltages and to select a second bias voltage from the plurality of second bias voltages in response to a first video data signal. A plurality of digital-to-analog converters operating as a plurality of current sources are configured to output a data line driving signal in response to a second video data signal and the selected second bias voltage.

The first video data signal may include i bits, and the second bias voltage generator may generate 2ⁱ number of different bias voltages. The second video data signal may include j bits, and each of the digital-to-analog converters may operate as 2^{j} number of different current sources.

At least one of the digital-to-analog converters may include a plurality of PMOS transistors configured to provide substantially equal current flows therethrough, and a plurality of switches connected to drains of the PMOS transistors and configured to turn the PMOS transistors on and/or off, thereby causing the PMOS transistors to serve as a plurality of current sources.

Respective ones of the PMOS transistors have sources connected to a power supply voltage, gates connected to the selected second bias voltage, and drains connected to one of the plurality of the switches.

The switches may be controlled by bits corresponding to the second video data signal. In some embodiments, j number of the switches may be provided, and 2^{j-1} of the PMOS transistors may be connected in parallel to one another and in series to the jth switch.

Respective ones of the digital-to-analog converters may include 2^{j}-1 number of PMOS transistors. At least two of the plurality of digital-to-analog converters may have the same circuit configuration.

A display device according to some embodiments of the invention includes a display panel including a plurality of scan lines, a plurality of data lines intersecting the scan lines, a plurality of pixels connected to the scan lines and the data lines, a timing controller configured to receive a video signal and to output a video data signal for driving the display panel, and a scan driver IC configured to sequentially activate the scan lines. The display device further includes a current-driven data driver IC including a bias voltage generator configured to generate a plurality of bias voltages, a decoder configured to select one of the bias voltages based on the video data signal, and a digital-to-analog converter configured to receive the selected bias voltage and the video data signal and to responsively generate a current that enables a plurality of gray levels to be represented. A voltage generator is configured to generate a power supply voltage at which the current-driven data driver IC and the scan driver IC are operable.

The bias voltage generator may be configured to receive an external power supply voltage and to generate the plurality of bias voltages. The digital-to-analog converter may include a plurality of PMOS transistors through which an equal current flows, and a plurality of switches connected to drains of the PMOS transistors and configured to turn the PMOS transistors on and/or off, thereby causing the PMOS transistors to serve as a plurality of current sources.

Respective ones of the PMOS transistors have sources connected to a power supply voltage, gates connected to the bias voltage selected by the decoder, and drains connected to one of the plurality of switches.

The switches may be controlled by bits corresponding to the video data signal.

The display device may further include a register configured to store the video data signal, and a level shifter configured to convert a voltage level of the video data signal and to provide the converted video data signal to the decoder and the digital-to-analog converter.

A display device according to some embodiments of the invention includes a display panel including a plurality of scan lines, a plurality of data lines intersecting the scan lines, and a plurality of pixels connected to the scan lines and the data lines, a timing controller configured to receive a video signal and to output a first video data signal and a second video data signal for driving the display panel, and a scan driver IC configured to sequentially activate the scan lines. The display device includes a current-driven data driver IC including a first bias voltage generator configured to generate a first bias voltage, a second bias voltage generator configured to receive the first bias voltage and to generate a plurality of second bias voltages in response to the first bias voltage, a decoder configured to receive the plurality of second bias voltages and to select one second bias voltage in response to the first video data signal, and a plurality of digital-to-analog converters configured to operate as a plurality of current sources to output a data line driving signal in response to the second video data signal and the selected second bias voltage. A voltage generator is configured to generate a power supply voltage at which the current-driven data driver IC and the scan driver IC are operable.

The first video data signal may include i bits, and the second bias voltage generator may generate 2ⁱ number of different bias voltages. The second video data signal may include j bits, and each of the digital-to-analog converters may operate as 2^{j} number of different current sources.

At least one of the digital-to-analog converters may include a plurality of PMOS transistors through which substantially equal currents flow, and a plurality of switches connected to drains of the PMOS transistors to turn the PMOS transistors on and/or off, thereby causing the PMOS transistors to serve as a plurality of current sources.

Respective ones of the PMOS transistors have sources connected to a power supply voltage, gates connected to the selected second bias voltage, and drains connected to at least one of the plurality of switches.

The switches may be controlled by bits corresponding to the second video data signal. In some embodiments of the invention, j number of the switches may be provided, and 2^{j-1} PMOS transistors may be connected in parallel to one another and may be connected in series to the jth switch.

Respective ones of the digital-to-analog converters may include 2j-1 number of PMOS transistors. At least two of the plurality of digital-to-analog converters may have the same circuit configuration.

### BRIEF DESCRIPTION OF THE DRAWINGS

The accompanying drawings, which are included to provide a further understanding of the invention and are incorporated in and constitute a part of this application, illustrate some embodiments of the invention. In the drawings:

FIG. 1 is a sectional view of a conventional organic EL structure for explaining an emission principle of an EL display;

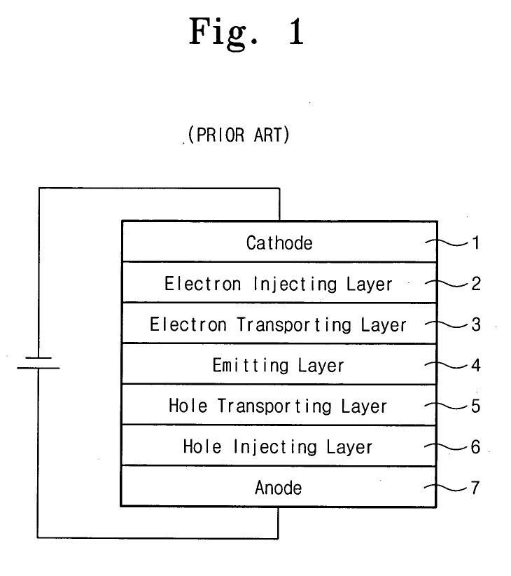

FIG. 2 is a circuit diagram of a conventional current-driven data driver IC;

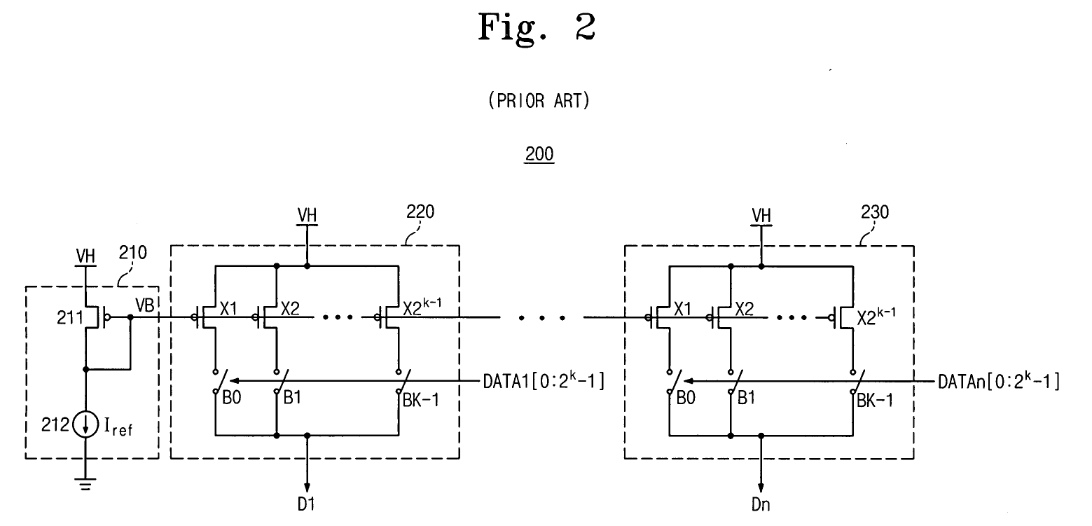

FIG. 3 is a circuit diagram of a conventional digital-to-analog converter with a 3-bit gray scale;

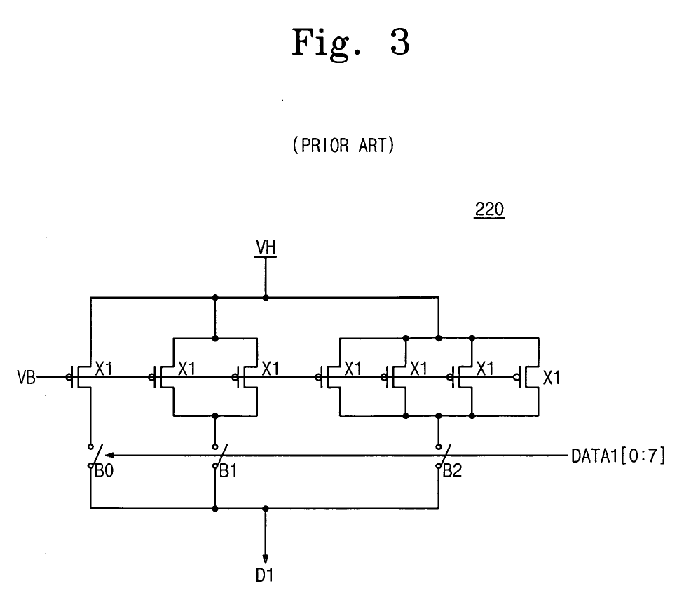

FIG. 4 is a block diagram of a general organic EL display;

FIG. 5 is a circuit diagram of a current-driven data driver IC according to some embodiments of the present invention; and

FIG. 6 is a block diagram of a current-driven data driver IC according to some embodiments of the present invention.

### DETAILED DESCRIPTION OF EMBODIMENTS OF THE INVENTION

Embodiments of the present invention now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

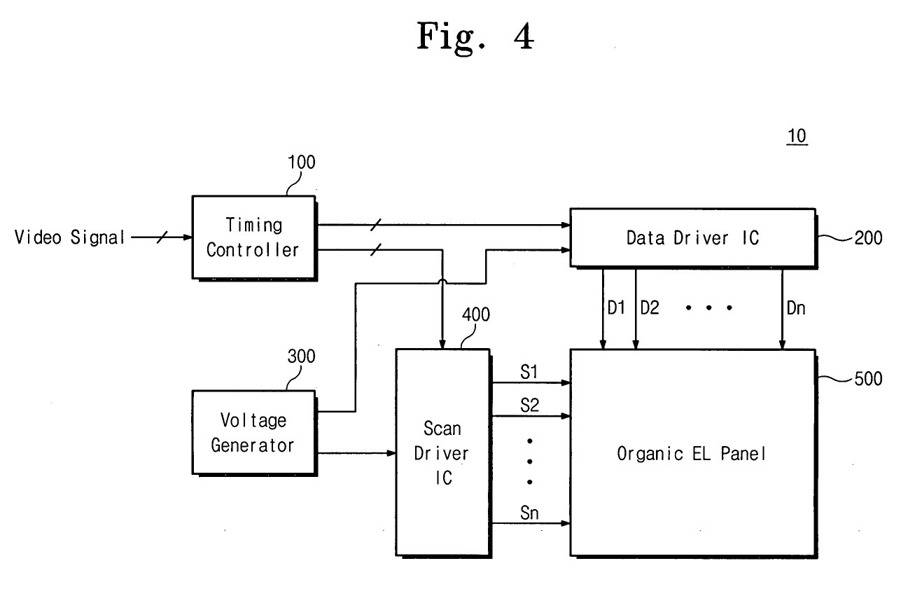

Unless otherwise defined, all terms (including technical and scientific terms) used herein have the same meaning as commonly understood by one of ordinary skill in the art to which this invention belongs. It will be further understood that terms used herein should be interpreted as having a meaning that is consistent with their meaning in the context of this specification and the relevant art and will not be interpreted in an idealized or overly formal sense unless expressly so defined herein. FIG. 4 is a block diagram of a general organic EL display. Referring to FIG. 4, an EL display 10 receives video data signals, sync signals, and clock signals, which are supplied from a host (not shown), and displays a color image on an organic EL panel 500.

The EL display 10 includes a timing controller 100, a data driver IC 200, a voltage generator 300, a scan driver IC 400, and an organic EL panel 500.

The timing controller 100 outputs video data signals at a timing required by the data driver IC 200 and the scan driver IC 400. In addition, the timing controller 100 outputs control signals for controlling the data driver IC 200 and the scan driver IC 400.

The voltage generator 300 generates voltages used in operating the EL display 10. For example, the voltage generator 300 may generate a power supply voltage of 3.3 V and a high voltage of 18 V, which may be used for driving the data driver IC 200.

The organic EL panel 500 includes a plurality of scan lines, a plurality of data lines intersecting the scan lines, and a plurality of pixels connected to the scan lines and the data lines. Each of the pixels may include an organic EL device.

The scan driver IC 400 outputs scan signals S1 to Sn for sequentially activating the scan lines in response to the control signals supplied from the timing controller 100. In this manner, all the scan lines of the organic EL panel 500 may be sequentially activated.

The data driver IC 200 receives the video data signals DATA1 to DATAn from the timing controller 100 and provides corresponding data line driving signals D1 to Dn to the pixels through the data lines.

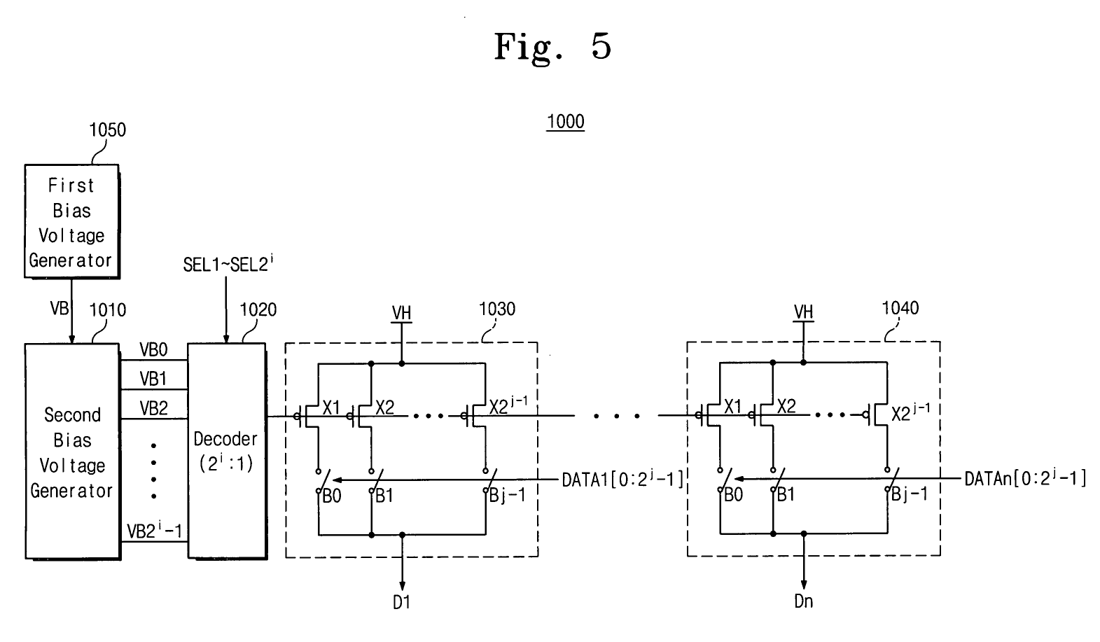

FIG. 5 is a circuit diagram of a current-driven data driver IC with a k-bit gray scale. Referring to FIG. 5, the data driver IC 1000 includes a first bias voltage generator 1050, a second bias voltage generator 1010, a decoder 1020, and n number of j-bit digital-to-analog converters 1030 to 1040.

The bias voltage generator 1050 receives the power supply voltage from the voltage generator 300 and generates a bias voltage VB serving as a reference voltage at which the second bias voltage generator 1010 can operate.

For the EL display 10 to represent a k-bit gray scale, the second bias voltage generator 1010 acts as a conventional digital-to-analog converter corresponding to i bits that are a part of the k bits. The second bias voltage generator 1010 receives the bias voltage VB from the first bias voltage generator 1050 and generates 2ⁱ number of bias voltages VB0 to VB2ⁱ-1 of different levels. For example, a 3-bit second bias voltage generator 1010 may generate eight (=2³) bias voltages VB0 to VB7 having different levels.

The decoder 1020 receives the bias voltages VB0 to VB2ⁱ-1 from the second bias voltage generator 1010 and selectively outputs one of the bias voltages VB0 to VB2ⁱ-1 in response to select signals SEL1 to SEL2ⁱ, which are output from the timing controller 100. The select signals SEL1 to SEL2ⁱ are values of some of the video data signals. The select signals SEL1 to SEL2ⁱ are used to select a bias voltage from among the plurality of the bias voltages according to information of the inputted video data.

The operation of the j-bit digital-to-analog converters 1030 to 1040 is similar to that of the conventional digital-to-analog converters 220 to 230. The j-bit digital-to-analog converters 1030 to 1040 are connected to the data lines D1 to Dn, respectively. All the j-bit digital-to-analog converters 1030 to 1040 may have the same circuit configuration.

For the EL display 10 to represent a k-bit gray scale, the j-bit digital-to-analog converters 1030 to 1040 implement the remaining j bits of the k-bit gray scale (j=k-i), since i bits are implemented by the second bias voltage generator 1010. The j-bit digital-to-analog converter 1030 includes a plurality of PMOS transistors and a plurality of switches B0 to Bj-1. The PMOS transistors serve as a current source. The PMOS transistors have sources connected to the voltage VH generated from the voltage generator 300, drains connected to their corresponding switches B0 to Bj-1, and gates connected to the bias voltages VB0 to VB2ⁱ-1 generated from the decoder 1020, respectively. The switches B0 to Bj-1 are respectively controlled by bits corresponding to video data signals DATA1 to DATAn provided from the timing controller 100. For example, the video data signals DATA1[0:2^{j}−1] are signals for driving the first data line D1, and the video data signals DATAn[0:2^{j}−1] are signals for driving an n-th data line Dn.

The video data signals DATA1 to DATAn for controlling the switching operations of the digital-to-analog converters 1030 to 1040 and the video data signals SEL1 to SEL2ⁱ for controlling the operation of the decoder 1020 are generated by the timing controller 100.

In the j-bit digital-to-analog converter 1030, the first switch B0 is connected to one PMOS transistor, the second switch B1 is connected to two PMOS transistors, and a j-th switch Bj-1 is connected to 2^{j-1} number of PMOS transistors. For example, in the case of the 3-bit digital-to-analog converter 1030, the respective switches are connected to one, two, and four PMOS transistors. Accordingly, 7 (=1+2+4) PMOS transistors may be used to configure the 3-bit digital-to-analog converter 1030.

For the EL display 10 to represent a k-bit gray scale, the second bias voltage generator 1010 implements i bits and the digital-to-analog converters 1030 to 1040 implement the remaining j bits of the k-bit gray scale (j=k−i). Therefore, compared with conventional device driver ICs using no second bias voltage generator 1010, the number of PMOS transistors used may be decreased, thereby potentially reducing the circuit complexity and/or chip size of the data driver IC 1000.

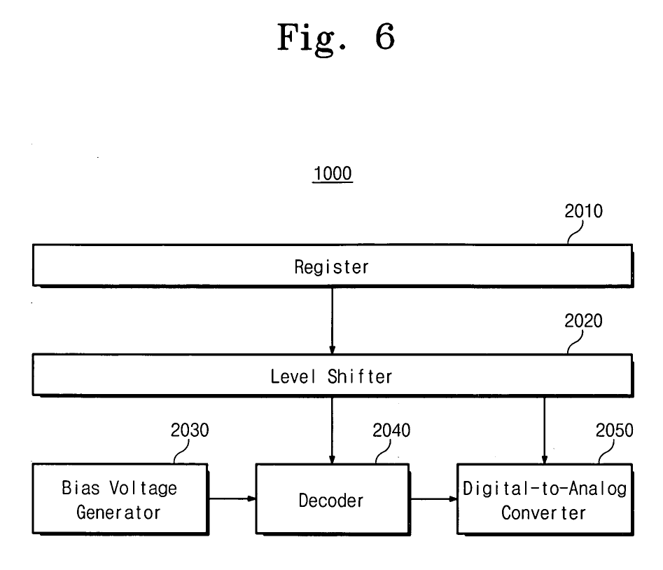

FIG. 6 is a block diagram of a data driver IC according to some embodiments of the present invention.

Referring to FIG. 6, the data driver IC 1000 includes a register 2010, a level shifter 2020, a bias voltage generator 2030, a decoder 2040, and a digital-to-analog converter 2050.

The register 2010 stores the video data signals provided from the timing controller 100. The level shifter 2020 changes the voltage level of the digital data signals of the register 2010, which is driven at a low voltage, before outputting the digital data signals to the decoder 2040 and the digital-to-analog converter 2050, which are driven at a high voltage. The bias voltage generator 2030 receives the power supply voltage from the voltage generator 300 (FIG. 4) and generates a plurality of bias voltages. Using the output signal of the level shifter 2020 as the select signal, the decoder 2040 selects one of the bias voltages inputted from the bias voltage generator 2030 and outputs the selected bias voltage to the digital-to-analog converter 2050. The digital-to-analog converter 2050 is configured with a plurality of transistors and a plurality of switches. The output signal of the level shifter 2020 controls the operations of the switches and thus the digital-to-analog converter 2050 generates a current that can represent a plurality of gray levels.

According to some embodiments of the present invention, the number of the PMOS transistors serving as the current source may be decreased, thereby potentially reducing the circuit complexity and/or chip size of the data driver IC.

In the drawings and specification, there have been disclosed typical embodiments of the invention and, although specific terms are employed, they are used in a generic and descriptive sense only and not for purposes of limitation, the scope of the invention being set forth in the following claims.

What is claimed is:

1. A current-driven data driver IC, comprising:
a bias voltage generator configured to generate a plurality of bias voltages;
a decoder configured to select one of the plurality of bias voltages based on a video data signal; and
a digital-to-analog converter configured to receive the selected bias voltage and to responsively generate an output current based on the video data signal.

2. The current-driven data driver IC of claim 1, wherein the bias voltage generator is configured to receive an external power supply voltage and to generate the plurality of bias voltages in response to the power supply voltage.

3. The current-driven data driver IC of claim 1, wherein the digital-to-analog converter comprises:
a plurality of PMOS transistors configured to provide substantially equal current flows therethrough; and
a plurality of switches connected to drains of the PMOS transistors and configured to turn the PMOS transistors on and/or off, thereby causing the PMOS transistors serve as a plurality of current sources.

4. The current-driven data driver IC of claim 3, wherein respective ones of the PMOS transistors have sources connected to a power supply voltage, gates connected to the bias voltage selected by the decoder, and drains connected to one of the plurality of switches.

5. The current-driven data driver IC of claim 3, wherein the switches are controlled by bits corresponding to the video data signal.

6. The current-driven data driver IC of claim 1, further comprising:
a register configured to store the video data signal; and
a level shifter configured to convert a voltage level of the video data signal and to provide the converted video data signal to the decoder and the digital-to-analog converter.

7. A current-driven data driver IC, comprising:
a first bias voltage generator configured to generate a first bias voltage;
a second bias voltage generator coupled to the first bias voltage generator and configured to receive the first bias voltage and to responsively generate a plurality of second bias voltages;
a decoder coupled to the second bias voltage generator and configured to receive the plurality of first bias voltages and to select a second bias voltage from the plurality of second bias voltages in response to a first video data signal; and
a plurality of digital-to-analog converters operating as a plurality of current sources and configured to output a data line driving signal in response to a second video data signal and the selected second bias voltage.

8. The current-driven data driver IC of claim 7, wherein the first video data signal comprises i bits, and wherein the second bias voltage generator generates 2ⁱ number of different bias voltages.

9. The current-driven data driver IC of claim 8, wherein the second video data signal comprises j bits, and each of the digital-to-analog converters operates as 2^{j} number of different current sources.

10. The current-driven data driver IC of claim 9, wherein at least one of the digital-to-analog converters includes:
a plurality of PMOS transistors configured to provide substantially equal current flows therethrough; and
a plurality of switches connected to drains of the PMOS transistors and configured to turn the PMOS transistors on and/or off, thereby causing the PMOS transistors to serve as a plurality of current sources.

11. The current-driven data driver IC of claim 10, wherein respective ones of the PMOS transistors have sources connected to a power supply voltage, gates connected to the selected second bias voltage, and drains connected to one of the plurality of the switches.

12. The current-driven data driver IC of claim 10, wherein the switches are controlled by bits corresponding to the second video data signal.

13. The current-driven data driver IC of claim 12, wherein j number of the switches is provided, wherein 2^{j-1} of the PMOS transistors are connected in parallel to one another and in series to the jth switch, and wherein each of the digital-to-analog converters includes 2^{j-1} number of PMOS transistors.

14. The current-driven data driver IC of claim 13, wherein respective ones of the plurality of digital-to-analog converters have the same circuit configuration.

15. A display device comprising:
a display panel including a plurality of scan lines, a plurality of data lines intersecting the scan lines, and a plurality of pixels connected to the scan lines and the data lines;
a timing controller configured to receive a video signal and to output a video data signal for driving the display panel;
a scan driver IC configured to sequentially activate the scan lines;
a current-driven data driver IC including:
a bias voltage generator configured to generate a plurality of bias voltages;
a decoder configured to select one of the bias voltages based on the video data signal; and
a digital-to-analog converter configured to receive the selected bias voltage and the video data signal and to responsively generate a current that enables a plurality of gray levels to be represented; and
a voltage generator configured to generate a power supply voltage at which the current-driven data driver IC and the scan driver IC are operable.

16. The display device of claim 15, wherein the bias voltage generator is configured to receive an external power supply voltage and to generate the plurality of bias voltages.

17. The display device of claim 15, wherein the digital-to-analog converter comprises:
a plurality of PMOS transistors configured to provide substantially equal current flows therethrough; and
a plurality of switches connected to drains of the PMOS transistors and configured to turn the PMOS transistors on and/or off, thereby causing the PMOS transistors to serve as a plurality of current sources.

18. The display device of claim 17, wherein respective ones of the PMOS transistors have sources connected to a power supply voltage, gates connected to the bias voltage selected by the decoder, and drains connected to one of the plurality of switches.

19. The display device of claim 17, wherein the switches are controlled by bits corresponding to the video data signal.

20. The display device of claim 15, further comprising:
a register configured to store the video data signal; and
a level shifter configured to convert a voltage level of the video data signal and to provide the converted video data signal to the decoder and the digital-to-analog converter.

21. A display device comprising:
a display panel including a plurality of scan lines, a plurality of data lines intersecting the scan lines, and a plurality of pixels connected to the scan lines and the data lines;
a timing controller configured to receive a video signal and to output a first video data signal and a second video data signal for driving the display panel;
a scan driver IC configured to sequentially activate the scan lines;
a current-driven data driver IC including:
a first bias voltage generator configured to generate a first bias voltage;
a second bias voltage generator configured to receive the first bias voltage and to generate a plurality of second bias voltages in response to the first bias voltage;
a decoder configured to receive the plurality of second bias voltages and to select one second bias voltage in response to the first video data signal; and
a plurality of digital-to-analog converters configured to operate as a plurality of current sources to output a data line driving signal in response to the second video data signal and the selected second bias voltage; and
a voltage generator configured to generate a power supply voltage at which the current-driven data driver IC and the scan driver IC are operable.

22. The display device of claim 21, wherein the first video data signal comprises i bits, and wherein the second bias voltage generator generates 2ⁱ number of different bias voltages.

23. The display device of claim 22, wherein the second video data signal comprises j bits, and wherein respective ones of the digital-to-analog converters operate as 2^{j} number of different current sources.

24. The display device of claim 23, wherein each of the digital-to-analog converters includes:
a plurality of PMOS transistors through which an equal current flows; and
a plurality of switches connected to drains of the PMOS transistors to turn the PMOS transistors on and/or off, thereby causing the PMOS transistors to serve as a plurality of current sources.

25. The display device of claim 24, wherein respective ones of the PMOS transistors have sources connected to a power supply voltage, gates connected to the selected second bias voltage, and drains connected to at least one of the plurality of switches.

26. The display device of claim 24, wherein the switches are controlled by bits corresponding to the second video data signal.

27. The display device of claim 24, wherein j number of the switches is provided, wherein 2^{j-1} PMOS transistors are connected in parallel to one another and are connected in series to the jth switch, and wherein respective ones of the digital-to-analog converters include 2^{j-1} number of PMOS transistors.

28. The display device of claim 27, wherein at least two of the plurality of digital-to-analog converters have the same circuit configuration.
